(19) United States
(12) Patent Application Publication
(10) Pub. No.: US 2004/0117405 A1
(43) Pub. Date: Jun. 17, 2004

(54) Relating media to information in a workflow system

(76) Inventors: Gordon Short, Palo Alto, CA (US); Doron Mysersdorf, Foster City, CA (US)

Correspondence Address: GLENN PATENT GROUP, 3475 EDISON WAY, SUITE L, MENLO PARK, CA, 94025, US

(21) Appl. No.: 10/649,008

(22) Filed: Aug. 26, 2003

Related U.S. Application Data
(60) Provisional application No. 60/406,010, filed on Aug. 26, 2002.

(51) Int. Cl. G06F 17/00

(52) U.S. Cl. 707/104.1

(57) ABSTRACT

A method for relating media to information in a workflow system provides pre-processed Natural Language Processing (NLP) tables of a database of informational content such as text documents, Web pages, images, video, music, etc., that provide information pertaining to a statistical and heuristic analysis of the informational content and description of the content. The tables are used for algorithmic comparison to other documents and media. The invention can be used in workflow applications and media applications, e.g., television set top boxes. The invention performs real time analysis of incoming media content or workflow content and algorithmically matches informational content that pertain to the media or workflow content using the pre-processed tables. This is through algorithmic analysis of the text in, and/or associated with, the informational content and the text in or associated with the incoming media content or workflow content. Referrals to any related informational documents and/or media are sent to the appropriate workflow or media application and are displayed to a user. The user can select any of the related documents for display or use in the workflow or media application.

### CROSS REFERENCE TO RELATED APPLICATIONS

This application claims benefit of U.S. Provisional Patent Application Serial No. 60/406,010, filed on 26 Aug. 2002.

### BACKGROUND OF THE INVENTION

1. Technical Field

The invention relates to real time information processing in a computer environment. More particularly, the invention relates to the preprocessing of information and relating the preprocessed information to real time media and text analysis.

2. Description of the Prior Art

Part of the Natural Language Processing (NLP) field deals with the analysis of text documents to classify the content for later searching. The processing of text in the documents typically involves performing statistical and heuristic analysis of words and character strings within the document and storing the results in table form. The resulting tables are used to search for documents that are relevant to words or character strings entered by a user.

A goal of this area of NLP is to associate documents using more than simple keywords. Search engines such as Google or Yahoo allow a user to enter a query phrase to search for relevant documents and Web pages. The user's query phrase is broken down into keywords which are then used to search documents and Web pages. The keyword search finds documents and Web pages containing the user's keywords.

Typically, the NLP document analysis is more involved than a keyword classification approach. This is one of the reasons why keyword search engines are more prevalent. However, both NLP and keyword search engines have not been used in a real time analysis application.

Interactive television has made many starts and stops in the past few years. Many of the reasons why were due to information accessibility (i.e., high speed data connections were not available to many consumers) and consumer lack of interest. The goal of many television set top box manufacturers (such as WebTV) was to have a fully interactive viewing experience for the viewer. The viewer would have the ability to participate in TV game shows, answer trivia questions during a television show, and send email to other viewers while viewing a television show.

One of the problems with previous generations of interactive television was that any operations that were meant to be linked to a specific television program had to be pre-produced to place tags within the broadcast stream. Content was pre-packaged to correspond with the appropriate tags and downloaded to the set top box. The tags were inserted into the program stream because the set top box had to key on a tag to be able to correlate and display the corresponding pre-packaged content to the scene in the program stream.

This approach also prevented the viewer from having an informational experience beyond the small amount of content that was downloaded to the user's set top box. The viewer could not obtain additional information, for example, on an educational subject from a PBS show, beyond the pre-packaged content. What is desired is for the viewer to be able to obtain information during any show that the viewer selects, rather than information being available only on pre-produced television programs.

The ability to obtain information in a real time analysis is also desirable in workflow applications. A workflow application involves a user that is performing a task such as text entry into a word processor. It would be beneficial to the user if an analysis of his text is performed contemporaneously with his text entry.

The analysis of the user's text would enable a system to provide additional information that applies to the subject of the text. This type of application would be extremely useful in a newsroom environment, for example, where a news editor could refer to additional information relating to a news subject without having to perform additional research.

It would be advantageous to provide a method for relating media to information in a workflow system that provides real time analysis of text and media content. It would further be advantageous to provide a method for relating media to information in a workflow system that relates information to analyzed content.

### SUMMARY OF THE INVENTION

The invention provides a method for relating media to information in a workflow system. The invention provides real time analysis of text and media content. In addition, the invention analyzes and classifies informational documents for relating information to analyzed content.

A preferred embodiment of the invention provides pre-processed Natural Language Processing (NLP) tables of a database of informational content such as text documents, Web pages, images, video, music, etc. The pre-processed tables provide information pertaining to a statistical and heuristic analysis of the informational content and description of the content. The tables are used for algorithmic comparison to other documents and media.

The invention can be used in workflow applications and media applications, e.g., television set top boxes. The invention performs real time analysis of incoming media content or workflow content and algorithmically matches informational content that pertain to the media or workflow content using the pre-processed tables. This is through algorithmic analysis of the text in, and/or associated with, the informational content and the text in or associated with the incoming media content or workflow content.

Referrals to the related informational documents and/or media are sent to the appropriate workflow or media application. The referrals are displayed to a user. The user can select any of the related documents and/or media for display. The user can use a selected informational document, for example, in his workflow application.

In media applications, the information about the program is metadata contained in the broadcast program and is extracted from the broadcast program. However, if the broadcast program does have associated metadata transmitted in-band, then the invention creates metadata for the program through analysis of the program material. Alternatively, the invention contacts the producer or broadcaster of the program to obtain metadata for the program.

The invention allows a producer, broadcaster, or content owner to supply customized informational content such as additional, relevant information which is related to the broadcasted program (e.g., background, product, purchasing, production, or future release information). The producer, broadcaster, or content owner has the ability to specify the relevance of its informational content.

Other aspects and advantages of the invention will become apparent from the following detailed description in combination with the accompanying drawings, illustrating, by way of example, the principles of the invention.

### BRIEF DESCRIPTION OF THE DRAWINGS

FIG. 1 is a block schematic diagram of a general system view of the invention according to the invention;

FIG. 2 is a block schematic diagram of a workflow application of the invention according to the invention;

FIG. 3 is a diagram of an exemplary word processor display implementing the invention according to the invention;

FIG. 4 is a block schematic diagram of an exemplary system structure for a set top box application of the invention according to the invention;

FIG. 5 is a diagram illustrating the flow of control of program material between a producer, broadcaster, and set top box according to the invention;

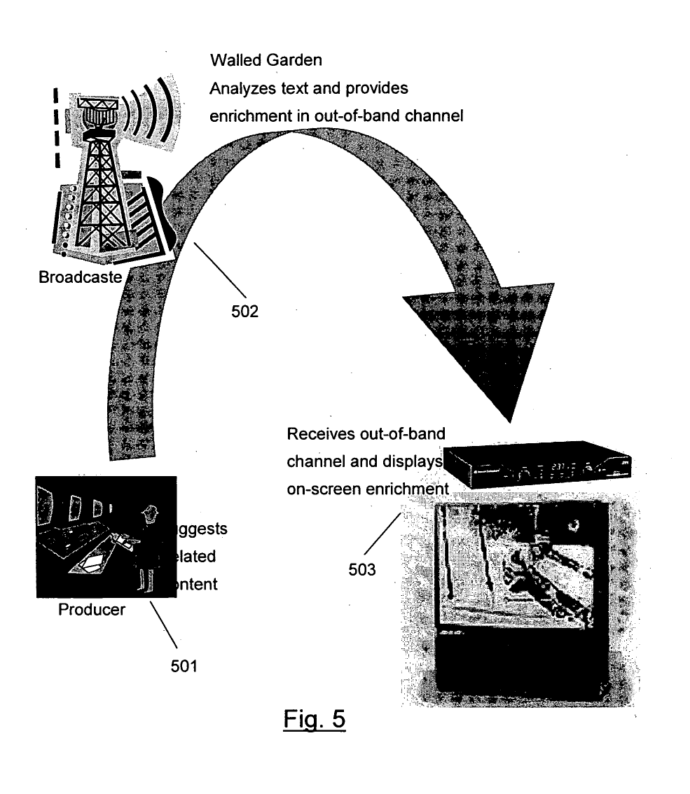

FIG. 6 is a diagram illustrating an exemplary user interface screen for a user query according to the invention;

FIG. 7 is a diagram illustrating an exemplary comparison of a page of information before and after the addition of related information to the subject matter according to the invention;

FIG. 8 is a diagram illustrating an exemplary user interface screen for a television viewer according to the invention;

FIG. 9 is a block schematic diagram illustrating the flow of control for creating a domain corpus according to the invention;

FIG. 10 is a block schematic diagram illustrating the flow of control for the Web harvesting of Internet information according to the invention; and

FIG. 11 is a block schematic diagram of an exemplary back-end implementation of the invention according to the invention.

### DETAILED DESCRIPTION OF THE INVENTION

The invention is a method for relating media to information in a workflow system. A system according to the invention provides real time analysis of text and media content. The invention additionally analyzes and classifies informational documents for relating information to analyzed content.

A preferred embodiment of the invention provides pre-processed Natural Language Processing (NLP) tables of a database of informational content such as text documents, images, video, etc. The pre-processed tables provide information pertaining to a statistical and heuristic analysis of the informational content and description of the content. The invention performs real time analysis of incoming media content or workflow content and matches information that pertains to the media or workflow content using the pre-processed tables. This is through algorithmic analysis of the text in, and/or associated with, the informational content and the text in or associated with the incoming media content or workflow content.

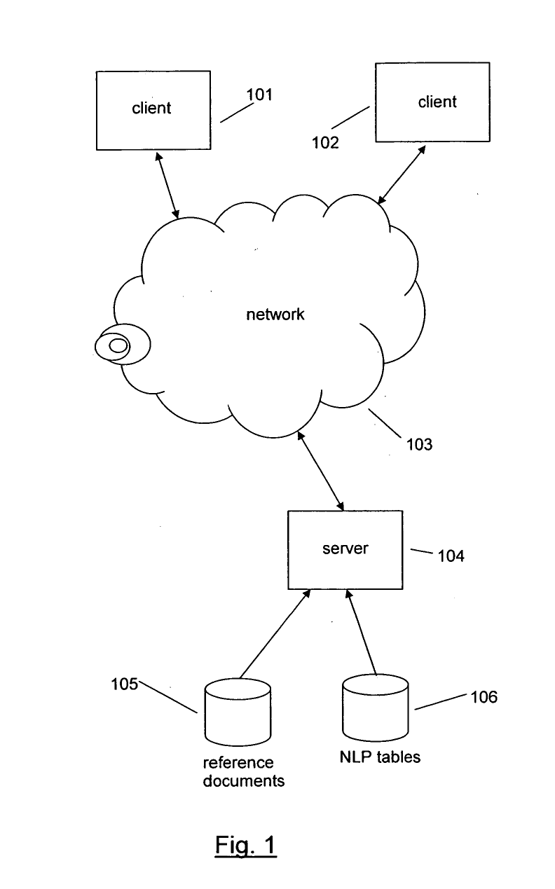

Referring to FIG. 1, a general application of the invention is shown. A server 104 stores NLP tables 106 on a storage device that have been created from statistical and heuristic analysis performed on reference documents 105 stored on a storage device. The reference documents 105 can be text documents and/or multimedia content.

The invention analyzes incoming media or workflow content in real time on client systems 101, 102. The media or workflow content could also be stored on the client and retrieved by the user. In that case, the invention analyzes the stored content as the user is viewing the content. The invention looks at the content itself and/or any in-band or out-of-band information that rides is associated with the content to perform its analysis.

As the invention analyzes the content, it sends the server 104 the ongoing results from the analysis through the network 103. The network 103 can be any communications connection such as the Internet, an intranet, modem, etc. Alternatively, the network 103 itself does not have to exist, for example, if the client system 101 and server 104 are located in the same machine.

The server 104 receives the analysis update and performs a relational search using the NLP tables 106. The server algorithmically selects documents using the NLP tables that are similar in words, semantically or conceptually, to the client's analysis. When the server 104 finds documents that are relevant to the analysis update, the server retrieves descriptions of the appropriate reference documents from the reference documents 105. The descriptions are sent to the appropriate client system 101, 102 where the client displays the reference document descriptions to the user.

The client sends a document request to the server 104 if the user selects any of the reference documents for display. The server 104 retrieves the requested documents from the reference documents 105 and sends them to the client. The client displays the requested documents to the user as appropriate.

The invention can be used in workflow applications and media applications, e.g., television set top boxes. Although media applications are also considered workflow applications, separate examples will be presented for clarification. One skilled in the art will readily appreciate that, although text-based workflow and television set top box examples are presented below, that the invention equally applies to other workflow and media applications. The invention provides an automated real time capability to relate content to content in a workflow environment.

Descriptions of sample applications are described below.

Workflow Applications

A preferred embodiment of the invention relates workflow content to information about the content. Workflow applications automate a business process during which documents, information, or tasks are passed from one resource (human or machine) to another for action, according to a set of procedural rules. There are many examples of workflow applications such as text entry, video editing, document reviewing, etc. There are also many different industries where workflow applications are used such as newspapers, newsrooms, movie productions, insurance companies, libraries, etc. A typical text workflow application involves a user that is performing a task such as text entry or review into a word processor.

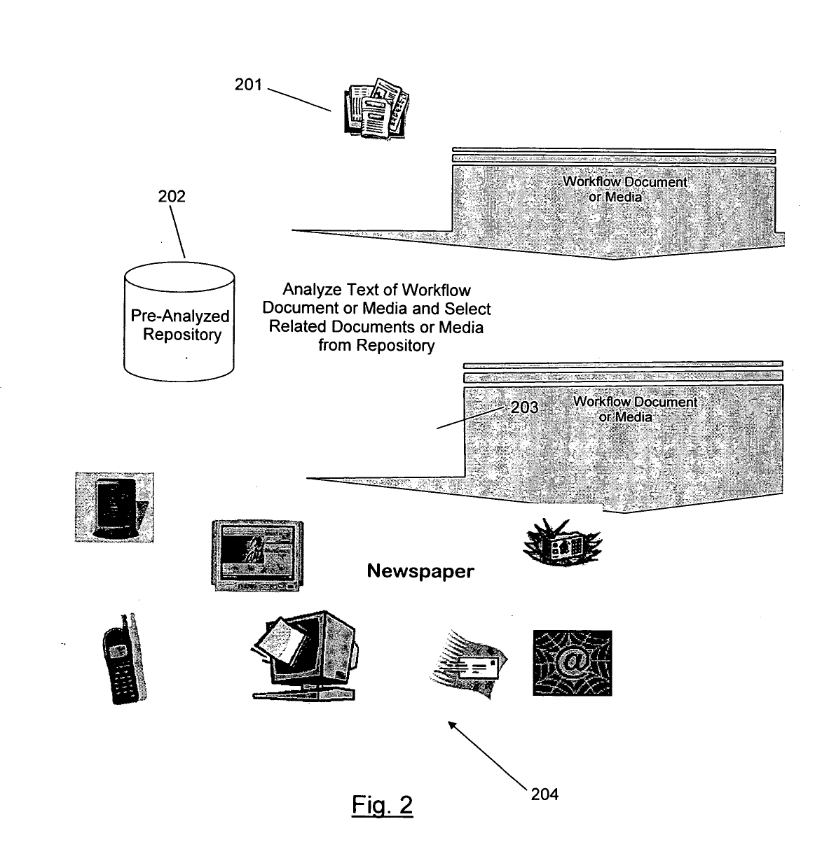

With respect to FIG. 2, several different types of technologies where workflow applications are enhanced by the invention. The invention performs automatic real time analysis of a workflow document or media 201. The typical workflow application allows serial processing of the incoming text or media, such as when a user is typing or when media (e.g., music, video, audio) is being played.

The invention provides a pre-analyzed repository of documents and media 202. Documents and media are processed by the invention using statistical and heuristic analysis to create the repository 202. Tables are created that characterize the pre-analyzed repository for later algorithmic comparison to other documents and media.

The invention uses its real time analysis of the incoming text or media to algorithmically select related documents and media from the pre-analyzed repository 202 that are similar in words, semantically or conceptually to the real time analysis. Referrals to the related documents and/or media are sent 203 to the appropriate workflow application 204. Workflow applications such as text editors, email editors, Web browsers, and media players reside in PDAs, PCs, cell phones, etc.

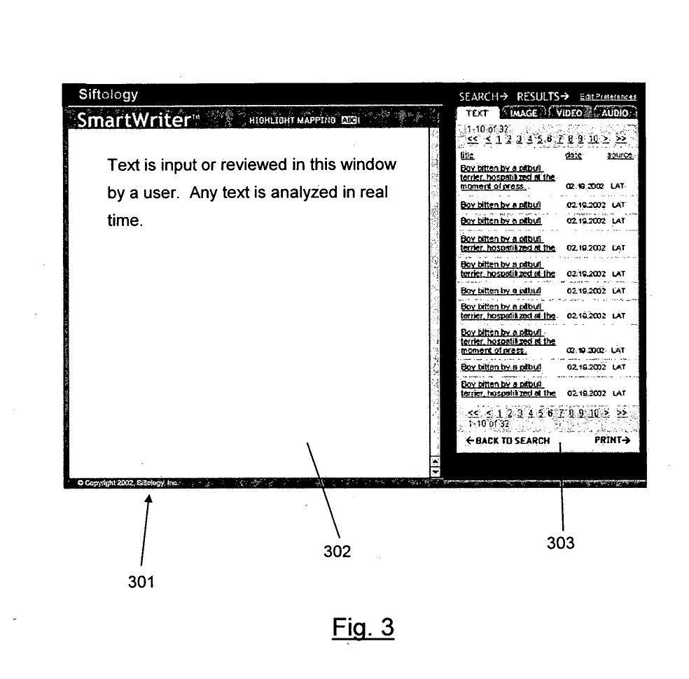

Referring to FIG. 3, an exemplary word processing application is shown. The word processing application window 301 has a text display window 302 and a related material window 303. For example, a knowledge worker, such as a journalist or editor, types in or reviews text in the text display window 302 for an article that he is preparing. As the user types, the text in the text display window 302 is analyzed in real time using NLP. Related material is dynamically selected from the repository and presented in a related material window 303.

The related material displayed in the related material window 303 may be used or referenced in the document in the text display window to enhance the workflow content. The user simply selects the description of a related material in the related material window 303 and the material is displayed to the user. The user then uses the material entirely, partially, or references the material in his document.

Any word processor can implement the invention using a plug in or similar instrument.

Television Set Top Boxes (STB)

The vast content available on the Internet and on extranets is thus far mostly limited to the PC. Companies that invested in generating this content are seeking additional outlets through a variety of information appliances. In addition, broadcasters (MSOs) and content providers are seeking revenues from the interactive TV (iTV) market, which has the potential to become more dominant than the traditional e-commerce. The iTV market has the following two need standpoints:

(1) media/television standpoint—networks and channels starve for Internet content and e-commerce businesses for television viewers; and

(2) viewer standpoint—television viewers are eager for attractive and entertaining navigation capabilities that enable visual interface to internet content and commerce.

A preferred embodiment of the invention relates media to information about the media. Applications such as STBs are an excellent example for a host for the invention. As mentioned above, one of the problems with previous generations of interactive television was that any operations that were meant to be linked to a specific television program had to be pre-produced to place tags within the broadcast stream. Content was pre-packaged to correspond with the appropriate tags and had to be downloaded to the set top box prior to the time the television show was broadcasted. The set top box would key on a tag to correlate and display the corresponding pre-packaged content to the scene in the program stream.

This approach prevented the viewer from having an informational experience beyond the small amount of content that was downloaded to the user's set top box. The viewer could not obtain additional information, for example, on an educational subject from a PBS show, beyond the pre-packaged content.

The invention provides a method to reach beyond the pre-packaged content of previous approaches by giving the viewer the ability to obtain information during any show that the viewer selects, rather than information being available only on pre-produced television programs. The viewer could theoretically have an entire public library at his fingertips for a more involved informational experience.

The invention further provides a broadcaster with the ability to create customized informational content for different movie genres, target audiences, specific programs, and offer merchandising and commerce opportunities to the viewer.

The streaming nature of television content allows the invention to constantly monitor the media content (both analog and digital) in real time while the viewer is watching his television programs. A user interface alerts the viewer that more information is available for the program that he is viewing. The user interface allows the viewer to display and explore the information via his set top box.

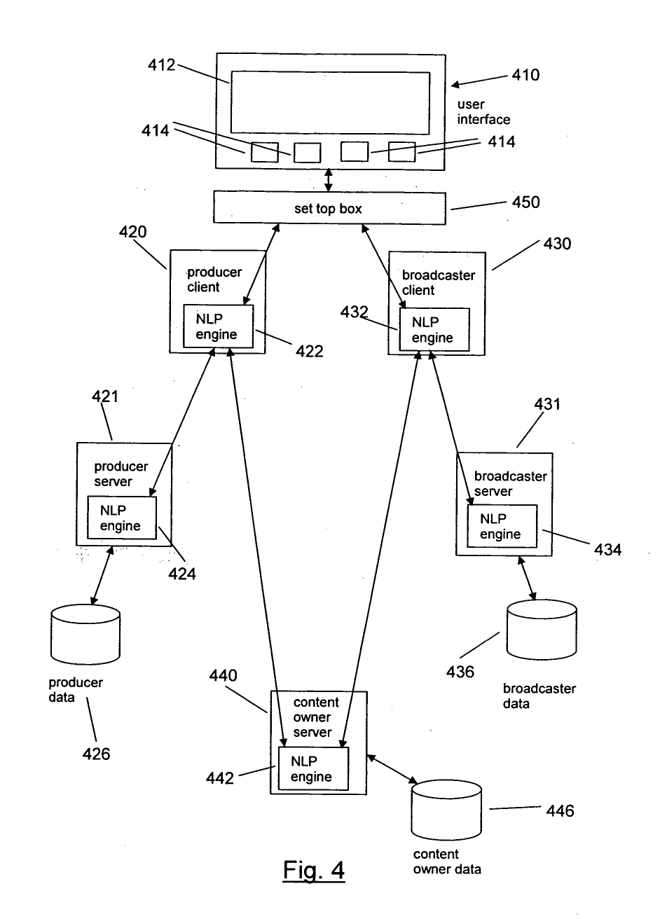

With respect to FIG. 4, the invention relates media to information about the media. An exemplary embodiment of the invention includes a user interface 310, producer client 320 and server 321, broadcaster client 330 and server 331, a content owner server 340, and a set top box (STB) 350.

Each producer, broadcaster, and content owner set of components allows each provider to customize the information available to the viewer. Each provider has a different focus on a television program's content. For example, a producer, such a Pixar, is more concerned with the background of the production or Pixar merchandising, while a broadcaster is more concerned with its sponsors and other related programs that it will air. A content owner, such as Disney, will be more concerned with background information on the subject matter (e.g., for educational programs), future DVD, video, and movie releases, advertising for merchandise, and other related information.

User Interface

User interface 410 includes a view screen 412 and command subscreens, or buttons, 414. The view screen 412 displays a media program. The user interface 410 is generated by the set top box 450 and typically displayed via a television monitor.

The command subscreens 414 allow for the control and display of ancillary information. The ancillary information is related to the displayed media program.

The command subscreens 414 allow for the entry of commands by the viewer. The commands are related to the media program displayed on view screen 412. Each command subscreen 414 is related to the displayed media program with commands that can include a request for information that is related to the displayed media program. The commands can also include a request for information which is unrelated to the displayed media program. Commands can be entered, for example, as text commands, voice commands, menu-driven commands, or icon commands.

Producer Components

The producer components include (1) a producer client 420 with a client-side NLP engine 422, (2) a producer server 421 with a server-side NLP engine 424, and (3) a producer data store 426. The producer client-side NLP engine 422, producer server-side NLP engine 424, and producer data store 426 are logically coupled as shown. The producer components enrich and deepen the content of a program that is produced by a producer by providing a producer-based informational source.

Requesting Relevant Information from the Producer

During normal operation, the producer client-side NLP engine 422 receives commands related to the produced program from user interface 410 via set top box 450. Commands are entered via command subscreens 414. For example, the commands include a request for information related to the produced program.

The producer client-side NLP engine 422 obtains information about the produced program in response to commands entered via command screen 414. The client-side NLP engine 422 can also obtain the information about the produced program in response to programmed settings. The information about the produced program is metadata contained in the produced program and is typically extracted from the produced program by the producer client. However, if the producer client is not resident in the set top box, then the set top box can extract the metadata information form the produced program and send it to the producer client 420.

In an alternative embodiment of the invention, the invention analyzes the produced program content to create its own metadata. In another alternative embodiment of the invention, the producer client-side NLP engine 422 contacts the producer of the program to obtain metadata for the program.

In yet another alternative embodiment of the invention, the producer client-side NLP engine 422 may reside in the producer's computer system.

Producer client-side NLP engine 422 communicates the information about the produced program to producer server-side NLP engine 424. The producer client-side NLP engine 422 queries producer server-side NLP engine 424, which is associated with producer data store 426, with metadata about the produced program. Producer data store 426 may be any data storage resource, such as a data archive, media, an Internet resource, an intranet resource, or an extranet resource.

Producer server-side NLP engine 424 provides a depth of knowledge related to the produced program and related to the information about the produced program to producer client-side NLP engine 422 in response to the query from producer client-side NLP engine 422. The depth of knowledge includes, but is not limited to, additional, relevant information which is related to the produced program and which enriches the user experience, or produced program, being displayed on view screen 412.

The producer server-side NLP engine 424 obtains the depth of knowledge related to the produced program from producer data store 426 using the information about the produced program. The producer server-side NLP engine 424 accesses producer data store 426 with the metadata from producer client-side NLP engine 422. Producer server-side NLP engine 424 develops a summary of the resources that are available from data store 426. The producer server-side NLP engine 424 can also maintain the summary of the resources which are available from data store 426.

The summary of resources includes an index, which relates the information about the produced program to the depth of knowledge in producer data store 426. The producer server-side NLP engine 424 obtains the depth of knowledge related to the produced program by using the information about the produced program to reference the index to producer data store 426.

Alternatively, the index can be, for example, a metadata index. In that case, the summary of resources includes a metadata index, which relates metadata to the depth of knowledge in producer data store 426. The producer server-side NLP engine 424 obtains the depth of knowledge related to the produced program and related to the metadata from producer client-side NLP engine 422 by using the metadata to reference the metadata index to producer data store 426.

The producer data store 426 gathers the depth of knowledge related to the produced program and related to the information about the produced program from various sources, such as server-side NLP engine 424, the producer itself, advertisers, companies making use of the present invention, the Internet, an intranet, or an extranet.

The producer, client-side NLP engine 422 provides the depth of knowledge related to the produced program and related to the information about the produced program to user interface 410 in response to commands related to the produced program. At least one command subscreen 414 displays the depth of knowledge from producer client-side NLP engine 422 in response to commands entered via command subscreen 414.

As described above, the depth of knowledge includes additional, relevant information which is related to the produced program and which enriches the user experience, or produced program, being displayed on view screen 412.

For example, if a producer produces a program on volcanoes, producer client-side NLP engine 422 obtains metadata contained in the program on volcanoes. In addition, producer client-side NLP engine 422 communicates a query based on the metadata to producer server-side NLP engine 424. Producer server-side NLP engine 424 obtains a depth of knowledge related to the produced program and related to the information about the produced program from producer data store 426. Producer server-side NLP engine 424 provides the depth of knowledge, such as information related to books on volcanoes, to producer client-side NLP engine 422. Producer client-side NLP engine 422 provides the depth of knowledge to user interface 410 in response to commands related to the produced program. At least one command subscreen 414 displays the depth of knowledge.

Broadcaster Components

Broadcaster components include (1) a broadcaster client-side NLP engine 432, (2) a broadcaster server-side NLP engine 434, and (3) a broadcaster data store 436. Broadcaster client-side NLP engine 432, broadcaster server side NLP engine 434, and broadcaster data store 436 are logically coupled as shown. Broadcaster client-side NLP engine 432 and broadcaster server-side NLP engine 434 communicate with each other. The broadcaster components are configured to associate television-commerce (t-commerce) activity with a program which is broadcasted by a broadcaster.

Broadcaster client-side NLP engine 432 receives from user interface 410 commands related to the broadcasted program. The commands are entered via command subscreen 414. The commands include a request for information related to the broadcasted program.

The broadcaster client-side NLP engine 432 obtains from a broadcaster, real-time information about the broadcasted program. Broadcaster client-side NLP engine 432 obtains the real-time information about the broadcasted program in response to commands entered via command subscreen 414. Alternatively, broadcaster client-side NLP engine 432 obtains the real-time information about the broadcasted program in response to programmed settings.

In an alternative embodiment of the invention, the real-time information about the broadcasted program is metadata contained in the broadcasted program. Broadcaster client-side NLP engine 432 accesses metadata contained in the output from the broadcaster when broadcaster client-side NLP engine 432 obtains information about the broadcasted program from the broadcaster. The metadata can include closed-caption text from the program that is broadcasted by the broadcaster.

Broadcaster client-side NLP engine 432 communicates the real-time information about the broadcasted program to broadcaster server-side NLP engine 434. The broadcaster client-side NLP engine 432 queries broadcaster server-side NLP engine 434, which is associated with broadcaster data store 436, with metadata obtained from the output from the broadcaster. The broadcaster data store 436 may be any data storage resource, such as a data archive, media, an Internet resource, an intranet resource, or an extranet resource.

The broadcaster server-side NLP engine 434 provides a depth of knowledge related to the broadcasted program and related to the real-time information about the broadcasted program to broadcaster client-side NLP engine 432 in response to the query from broadcaster client-side NLP engine 432. The depth of knowledge includes, but is not limited to, additional, relevant information which is related to the broadcasted program and which enriches the user experience, or broadcasted program, being displayed on view screen 412.

Broadcaster server-side NLP engine 434 uses the real-time information about the broadcasted program from broadcaster data store 436 to obtain the depth of knowledge related to the broadcasted program. The broadcaster server-side NLP engine 434 accesses broadcaster data store 436 using the metadata from broadcaster client-side NLP engine 432. Broadcaster server-side NLP engine 434 develops a summary of the resources which are available from broadcaster data store 436. The broadcaster server-side NLP engine 434 can also maintain the summary of the resources which are available from broadcaster data store 436.

The summary of resources includes an index, which relates the real-time information about the broadcasted program to the depth of knowledge in broadcaster data store 436. Broadcaster server-side NLP engine 434 obtains the depth of knowledge related to the broadcasted program by using the real-time information about the broadcasted program to reference the index to broadcaster data store 436.

In an alternative embodiment of the invention, the index is a metadata index. The summary of resources includes a metadata index, which relates metadata to the depth of knowledge in broadcaster data store 436. The broadcaster server-side NLP engine 434 obtains the depth of knowledge related to the broadcasted program and related to the metadata from client-side NLP engine 432 by using the metadata to reference the metadata index to broadcaster data store 436.

The broadcaster data store 436 gathers the depth of knowledge related to the broadcasted program and related to the real-time information about the broadcasted program from various sources, such as broadcaster server-side NLP engine 434, the broadcaster, advertisers, companies making use of the present invention, the Internet, an intranet, or an extranet.

Broadcaster client-side NLP engine 432 provides the depth of knowledge related to the broadcasted program and related to the real-time information about the broadcasted program to user interface 410 in response to commands related to the broadcasted program. At least one command subscreen 414 displays the depth of knowledge from broadcaster client-side NLP engine 432 in response to commands entered via command subscreen 414.

As described above, the depth of knowledge includes additional, relevant information which is related to the broadcasted program and which enriches the user experience, or broadcast program, being displayed on view screen 412.

For example, if a broadcaster broadcasts a program on volcanoes, broadcaster client-side NLP engine 432 obtains metadata contained in the program on volcanoes. In addition, broadcaster client-side NLP engine 432 communicates a query based on the metadata to broadcaster server-side NLP engine 434. Broadcaster server-side NLP engine 434 obtains a depth of knowledge related to the broadcasted program and related to the real-time information about the broadcasted program from broadcaster data store 436. Broadcaster server-side NLP engine 434 provides the depth of knowledge, such as information related to books on volcanoes, to broadcaster client-side NLP engine 432. The broadcaster client-side NLP engine 432 provides the depth of knowledge to user interface 410 in response to commands related to the broadcasted program. At least one command subscreen 414 displays the depth of knowledge.

Content Owner Component

Content owner component includes (1) a content owner server NLP engine 442 and a content owner data store 446. Content owner NLP engine 442 and content owner data store 446 are logically coupled as shown. The content owner component is configured to associate content from a content owner with producer client-side NLP engine 422, as shown. The content owner server 440 is configured to associate content from a content owner with broadcaster client-side NLP engine 432, as shown.

The content owner NLP engine 442 communicates information about the content from a content owner to producer client-side NLP engine 422. Content owner NLP engine 442 can also communicate information about the content from content owners to broadcaster client-side NLP engine 432.

Content owner NLP engine 442 obtains a depth of knowledge about the content from content owner data store 446. The content owner data store 446 gathers the depth of knowledge related to the content from various sources, such as content owner NLP engine 442, content owners, advertisers, companies making use of the present invention, the Internet, an intranet, or an extranet.

The content owner NLP engine 442 communicates the depth of knowledge related to the content to producer client-side NLP engine 422. The content owner NLP engine 442 can also communicate the depth of knowledge related to the content to broadcaster client-side NLP engine 432.

STB Component

The set top box (STB) component includes a thin application which provides user interface 410. The thin application is integrated with an application that is enabled in the set top box. The STB 450 is connected to a display mechanism such as a television monitor where the user interface 410 is displayed. The STB is the main user interface to the producer 420, 421 and broadcaster 430, 431 components.

Enriching iTV

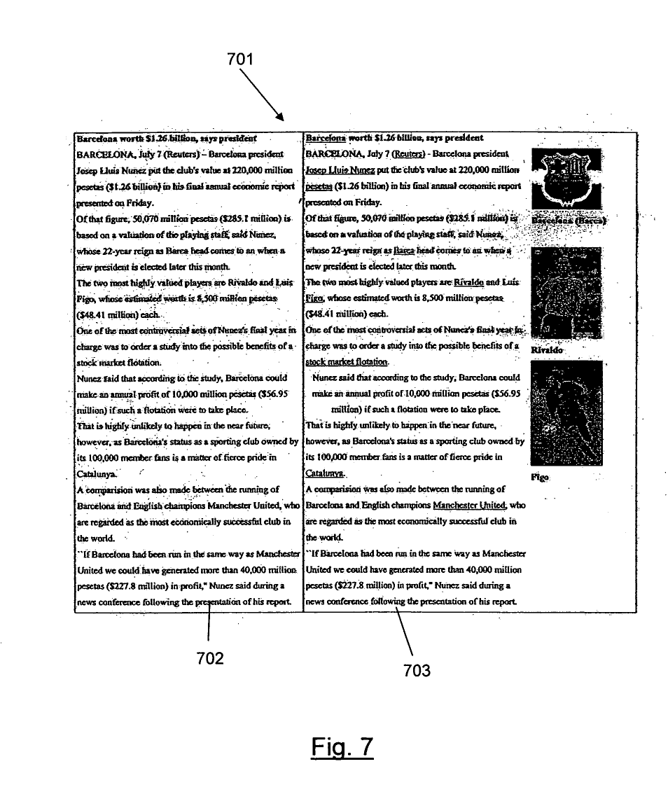

With respect to FIG. 7, another embodiment of the invention allows a producer 701 to suggest related content. The broadcaster 702 is provided with a walled garden (discussed below). As a program is prepared or broadcast, the closed-caption text is analyzed. Categories are automatically prepared and content related to the broadcast is automatically added to the broadcast stream.

As the STB 703 receives the broadcast, the closed captioned text is analyzed and related content is displayed. For example, analysis of the closed-caption text could result in an online trading option being offered to the viewer.

Constructing an Index to Access Different Parts of Source of Data

Given a source of data (e.g., a film, a DVD, video on demand, interactive television, etc.), the invention constructs an index to access different segments (e.g., scenes) of the source of data according to textual queries. An exemplary index usage is “Show me the scene where Jon says to Mary that he loves her.” The textual query can be a quotation from the source of the data, a “near quotation”, or a general search request. Additionally, the index can be accessed via browsing (a hierarchy of segments is then built, not necessarily according to chronological sequence). In this case, a user does not need to type a query. Instead, the user navigates through a set of categories until he finds the desired segment. Another possible usage is to list key phrases and access different segments according to key phrases.

Generating a Summarized Form of a Source of Data

The invention generates a summarized, dense form of a source of data (e.g., the Web or for any other media, such as telephony). The invention performs one or more of the following:

decomposes a source of data into segments;

identifies a representative video frame for each segment;

summarizes the segment;

puts on the Internet the resulting sequence of video frames with the respective summaries; and

builds an index to access different segments.

Extracting Content from a Web Page

The invention provides a content extractor that extracts high quality data from Web pages. The content extractor includes a page recognizer and a selector. The page recognizer and the selector extract information from the Internet.

The page recognizer categorizes Web pages (or their subframes) to determine their function. For example, the page recognizer categorizes a Web page and determines whether the Web page is one or more of the following:

(a) a homepage of a company;

(b) a homepage of a person;

(c) a gallery of pictures;

(d) a list of links (index page);

(e) a dynamic page; and

(f) a shopping page (just text).

The selector selects the part of a given page that contains meaningful media, such as text suitable for applying NLP tools, or a portion that is meaningful for image processing. Similarly, pages that are designed for commerce can be automatically translated for the appropriate applications. Pages that are from the Web site of a person or a company can be used to extract logos, pictures, addresses, etc. The category is selected by the invention which knows which application to use and what data to extract.

Updating Breaking News

The invention provides a breaking news updater that is used for content syndication. The breaking news updater is a tool that automatically extracts and syndicates content from news sources on the Internet, television, and radio. It also enables the presentation or display of breaking news from the various sources. The breaking news updater uses both text analysis, categorization, and confirmation on the various sources. The breaking news updater can be used for any push technology, such as SMS, broadband, or television.

How does it look?

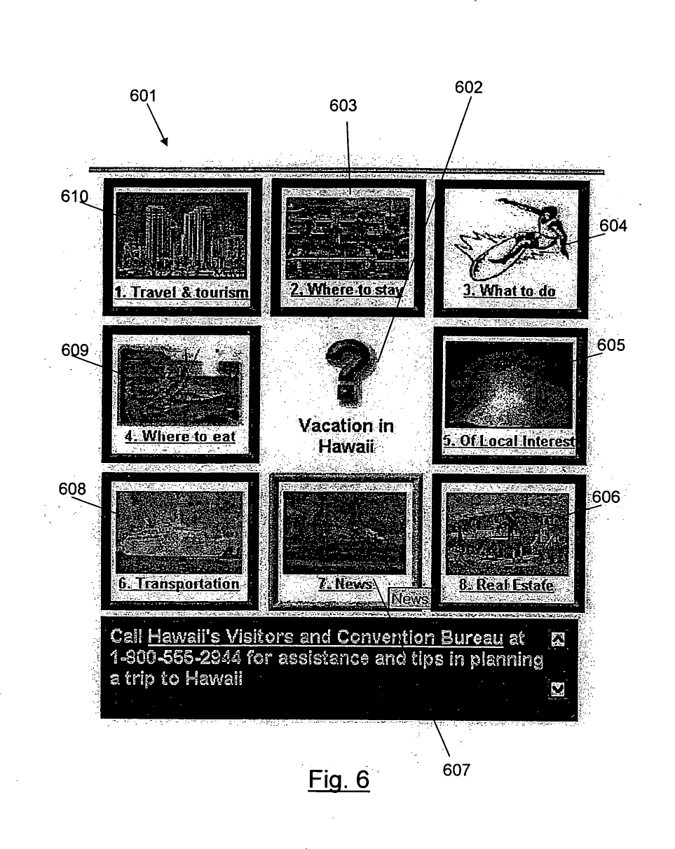

Referring to FIGS. 6 and 7, the invention's services can be displayed in many ways. Two examples are shown in FIGS. 6 and 7. FIG. 6 shows a search engine where a user queried: “vacation in Hawaii” 602. The reply page 601 shows the invention's clustering and visualization services 603-610.

FIG. 7 shows an exemplary content enrichment service 701. The left column 702 shows a news item before the invention's relational processing. The right column 703 shows the same article with the enrichment of links. These links are to the Internet, customer resources, and related images.

General

The invention offers the viewer of interactive TV (iTV) a compelling and fully enriched experience 24 hours a day, 7 days a week, on all channels, delivering rich, related content and associated T-commerce. The invention allows content producers, networks and broadcasters to deliver a breakthrough, interactive, compelling experience to iTV viewers. This differentiated experience maximizes viewer satisfaction, drives retention, and creates new revenue opportunities at the last inch, at the last mile, and at the studio.

The invention turns on iTV by providing technology and tools to the iTV industry to dramatically change the pace and capability of the industry to enrich programming. The invention leverages existing video, text and audio assets to further enhance work in production. It integrates into the “content manufacturing line” at all points: at the content producer; at the broadcaster (MSO); and at the STB. It is additionally capable of providing enrichment services by providing purchased access to indexed third party archives.

Producer Solutions

The invention's Indexer, for the enrichment archive, leverages vested content and organizes it dynamically for the producer during creation. This ensures that the most comprehensive and accurate content is available to the producer.

The invention's solutions allow producers (the studios, stations, channels and networks) to efficiently and effectively generate multiple layers of iTV content. This enables a more compelling experience, developing increased satisfaction and loyalty, and also facilitates reduced production costs and incremental revenue. For the broadcaster, the present invention is a real-time t-commerce generator which exposes and associates the relevant content from the walled garden automatically and quickly. This results in providing shopping opportunities and engaging the viewer by providing an interactive and entertaining experience, resulting in longer sessions, enhanced loyalty and improved retention.

The invention's Production Workbench, for the producer, researcher, and the script producer, generates and populates iTV layers with enriching material and related t-commerce. This provides a richer information structure and generates links to additional related categories and functions. This tool provides more efficient development of iTV broadcast programs. It is this completeness of content presentation to the producer that delivers on the invention's promise for a more compelling experience for the viewer.

The invention's OEM, for the tools industry provides the functional enhancement capability to a third party application. Used in conjunction with the invention's Indexer, a third party tool is able to utilize the enrichment archive. This increases the capability and productivity of the third party tools.

Broadcaster Solutions

The invention's Walled Garden, indexes and organizes content in a walled garden, providing additional enriching archives and t-commerce promotions. It enables the broadcaster to build revenue opportunity with selected content and promotions.

The invention's Real-time Broadcast Analyzer, analyzes broadcasts as they pass through the broadcasters' or MSO systems and associates and uses the invention's Walled Garden to enrich the broadcast with additional material and t-commerce.

Set Top Box (STB) Solutions

The present invention's Set Top Box, is an application that completes the end-to-end delivery of the invention's enriched experience. This application provides links into the iTV infrastructure which activates the return path for viewer selection and t-commerce.

Enrichment Solutions

The invention's Enrichment Engine, indexes an archive and provides an interface for enriching content for producers and broadcasters. Owners of content use this product to sell access their material.

The invention's Internet Index is an index of freely available content on the Internet that may be used by producers and broadcasters to enrich their programs.

The invention charges both for licensing of the NLP engines and for the ongoing service of updating the content of the repository database and mirroring it to various server locations.

Four categories of revenue source are as follows:

(1) licensing fees of the set-top boxes;

(2) television channels;

(3) local portals and television stations; and

(4) e-commerce portals and content providers (extranets).

NLP Application

The invention's NLP application relates video content with other sources of information (walled garden Internet, channel domain, e-commerce) that is customized for the viewer. The content shown to the viewer changes dynamically based on the time of day, time of year, viewer profile (young, old, male, female, other), program being watched, and other parameters.

Main Menu

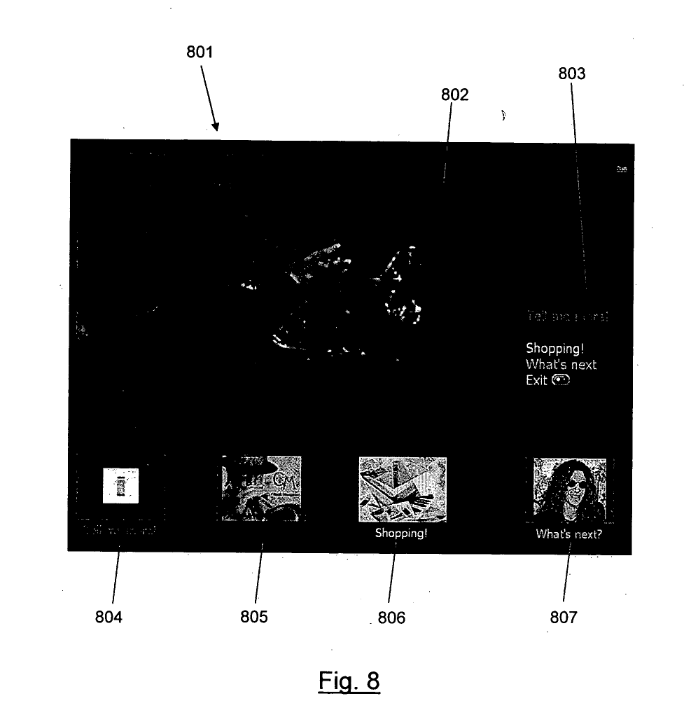

With respect to FIG. 8, the Main Menu 801 of NLP consists of three parts:

Navigation Menu (right) 803

Television program (center) 802

Additional information (bottom) 804-807

There are four types of information presented to the user:

1. Tell me more 804— related intranet and walled garden Internet Web site summaries.

2. Buy Now 805— a “hot” item that is related to the current context of the television program.

3. Other 806— more miscellaneous, information. Can be more e-commerce items or additional information.

4. What's Next 807— describes what is on the next segment of the television program or what is the next television program.

Tell Me More

Tell Me More 804 opens four more boxes with a multimedia image and description for items related to the current context of the television program. When the viewer clicks on a “Tell Me More” square, a short summary of the item (intranet site, walled garden Internet site, or other information) appears with the option to send the entire Web site or article to the user's email.

The user can branch each “Tell Me More” square to additional squares based on the amount of information available on the topic of the television program.

Buy Now

The Buy Now option 805 shows the viewer the item that is available for purchase.

Other

The Other option 806 is for additional e-commerce items to sell to the viewer or other related information (intranet, walled garden Internet site, or commercials).

What's Next

The What's Next option 807 shows an image or media clip about the next segment of the television program on the channel. Clicking the What's Next square shows four more What's Next squares with the next programs on the channel. When the viewer clicks on the What's Next square that represents the program that he wants to watch, a summary of the program is displayed. The viewer has the option to click on a Remind Me option on the summary which will send a reminder to the STB at the broadcast time of the program.

Learning the Language/Domain

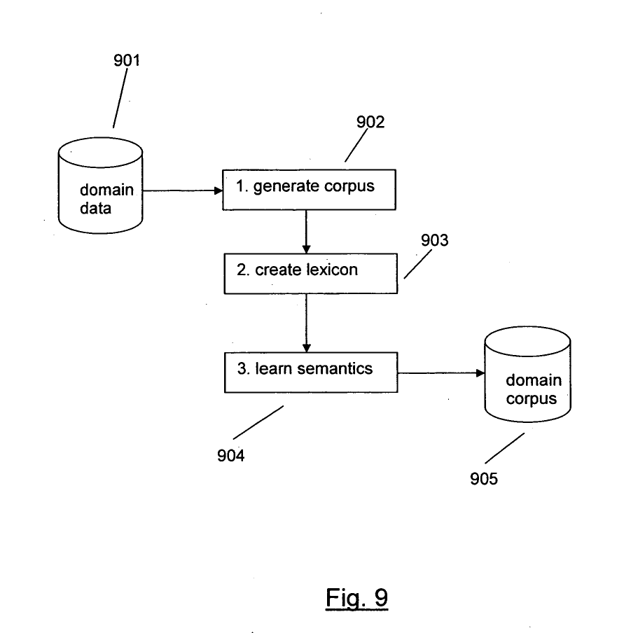

Referring to FIG. 9, the invention uses the flow shown to generate a corpus 905 (a set of words ranked by importance) which is used to generate signatures (vector of keywords and importance) of blocks of text.

Generate Corpus

The Generate Corpus stage 902 gathers the text from the Domain Data 901 to be processed.

Create Lexicon

The Create Lexicon stage 903 includes an Extract Words stage, an Extract Collocations stage, and a Morphology stage.

The Extract Words stage takes the data from the corpus and creates a list of words and calculates the frequency that they appear in the corpus.

The Extract Collocations stage generates collocations (pairs, triples, etc.) of words that appear together and calculates the frequency of the pair and the frequency of the words appearing together in the corpus.

The Morphology stage translates similar words into the same word (e.g., Flies->fly, wanted->want).

Learn Semantics

The Learn Semantics stage 904 finds relations between collocations to learn their meaning/context (e.g., New York->city in US, Star Wars->movie).

Signature and Fingerprint

The invention uses a signature algorithm to calculate signatures for blocks of text. A signature is a vector of words and their weighting within the document. The weighting is determined by the importance of the word in the collocations and within the document.

Each block of text has a unique signature that can be used to cross-reference against other blocks of text. The present invention calculates signatures for Web pages, text tags associated with images, and blocks of text.

Inverted Index

The inverted index algorithm creates an index for each word from the signature vector for a text document and then saves the index, word, text document, and weight of the word into a database that can be used later to find text documents that have similar signatures.

Clustering, Classification, and Categorization

The present invention uses the signature of the text document to do:

Mathematical clustering.

Match text documents to predefined categories.

Cross-reference the document to other similar documents using the signature for each document.

Clustering

The clustering algorithm uses the signatures and weights of the words to create sets of documents that have similar signatures.

Categorization

The categorization algorithm calculates signatures for predefined categories. The categorization algorithm then matches signatures for other text documents to the signatures of the pre-defined categories and determines which categories to assign to the text document.

As more documents are processed, the signatures for the predefined categories are improved to improve the accuracy of the categorization.

Cross-Referencing/What's Related

The invention uses a formula to calculate the similarity score between two or more documents. Documents that have a similarity score near the threshold limit are defined as similar documents. Calculating similarity scores between two or more documents is well known in the art.

Web Harvesting

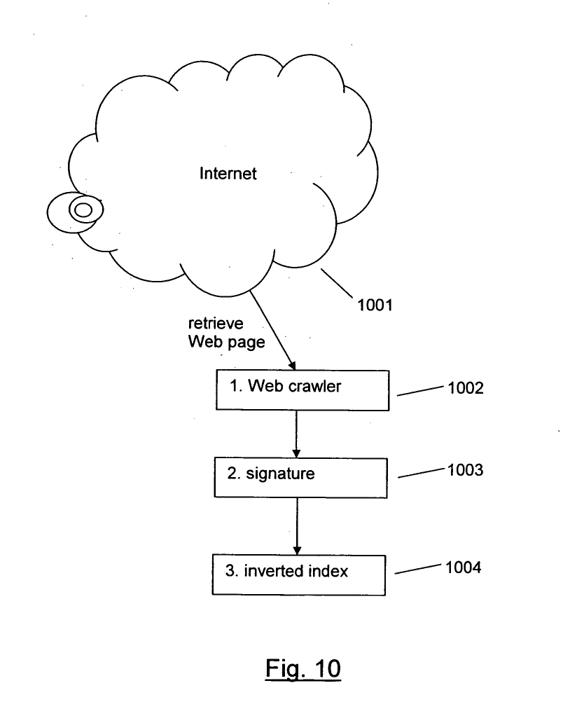

With respect to FIG. 10, the invention collects text documents and multimedia from Web pages across the Internet 1001 using a Web crawler 1002. The Web crawler 1002 retrieves entire Web pages and indexes them into the database. The invention calculates the signatures 1003 for each page. The inverted index for each signature is generated 1004 and put into the database.

Image Extraction

The invention collects images and other multimedia from text documents for:

Displaying multimedia for categories.

Representing a slideshow of web pages.

Visually define terms or context.

The image extractor uses heuristics about the size of the image, the location of the image in the document, and the text surrounding the image to identify good images and store them in a multimedia database. The text surrounding the image is used to create a signature and insert the image's signature in the inverted index table.

The invention uses a program to reduce the size of images in the multimedia database for use in the TV user interface application. The invention also uses an algorithm to capture images of Web pages and use them as visual representations of the Web pages in the TV user interface application.

NLP System Architecture

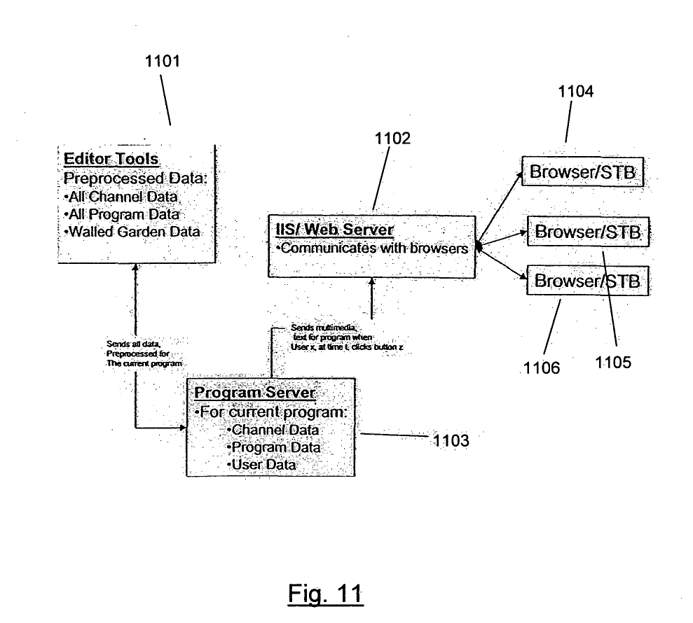

Referring to FIG. 11, the invention's back-end system for the NLP application is split into three parts:

1. Editor Tools 1101

2. IIS/Web Server 1102

3. Program Server 1103

The separation of the three parts is virtual and can be a combination of one to three machines.

Editor Tools

The Editor Tools server 1101 contains all of the data for the domain including:

1. multimedia

2. walled garden Internet

3. domain data including intranet and e-commerce data

4. data related to the television programs shown on the domain

The Editor Tools server 1101 allows the domain Web-TV content editor to edit what Web sites, intranet pages, e-commerce items, multimedia, and other data is available to the user and the time in each program that the items are available.

Program Server

The Program Server 1103 downloads the information for the television program that is going to be shown next from the Editor Tools 1101. The Program Server 1103 sends data to the Web Server 1102 when the Web Server 1102 requests the data for a viewer's STB 1104.

IIS/Web Server

The Web Server 1102 communicates with the STBs 1104, 1105, 1106 and transfers the data needed for the NLP application. The IIS/Web Server 1102 also handles all e-commerce requests and additional requests for more information from the user.

Although the invention is described herein with reference to the preferred embodiment, one skilled in the art will readily appreciate that other applications may be substituted for those set forth herein without departing from the spirit and scope of the present invention. Accordingly, the invention should only be limited by the claims included below.

1. A process for real time analysis of text and/or media content and relating information to the content, comprising the steps of:
analyzing said content in real time;
wherein said analyzing step analyzes said content for semantic and conceptual use;
providing a set of informational documents;
wherein said informational documents comprise any of text, Web, and media documents;
providing a pre-processed analysis of said informational documents;
wherein said pre-processed analysis is an analysis of said informational documents for semantic and conceptual use;
identifying informational documents related to said analyzed content using said pre-processed analysis;
providing a user with a description of each identified informational document;
accepting user input for selecting an identified informational document; and
displaying the selected identified informational document to the user.

2. The process of claim 1, wherein said identifying step identifies related informational documents by finding informational documents that are similar in words, semantically or conceptually, to the analyzed content.

3. The process of claim 1, further comprising the step of:
storing descriptors for each informational document.
retrieving descriptions of each identified informational document from said stored descriptors.

4. The process of claim 1, wherein said set of informational documents are stored in a central storage device.

5. The process of claim 1, wherein said pre-processed analysis creates a list of words and calculates the frequency that the words appear in said set of informational documents.

6. The process of claim 5, wherein said pre-processed analysis translates similar words into the same word.

7. The process of claim 1, wherein said pre-processed analysis generates collocations of words that appear together and calculates the frequency of pairs of words and the frequency of the words appearing together in said informational documents.

8. The process of claim 7, wherein said pre-processed analysis finds relations between collocations to learn their meaning/context.

9. The process of claim 1, wherein said pre-processed analysis uses a signature algorithm to calculate signatures for blocks of text, wherein a signature is a vector of words and their weighting within an informational document; wherein the weighting is determined by the importance of a word in the collocations and within the document.

10. The process of claim 9, wherein said pre-processed analysis calculates signatures for Web pages, text tags associated with images, and blocks of text.

11. The process of claim 9, wherein said pre-processed analysis creates an index for each word from a signature vector for an informational document and saves the index, word, text document, and weight of the word into a database that is used to find text documents that have similar signatures.

12. The process of claim 9, wherein said pre-processed analysis uses the signatures and weights of the words to create sets of documents that have similar signatures.

13. The process of claim 1, further comprising the step of:
collecting text documents and multimedia from Web pages across the Internet using a Web crawler and placing them into said set of informational documents.

14. A process for real time analysis of text and/or media content in a workflow application and relating information to the content, comprising the steps of:
automatically analyzing said content in real time as said content is being entered or reviewed by a user;
wherein said analyzing step analyzes said content for semantic and conceptual use;
providing a set of informational documents;
wherein said informational documents comprise any of text, Web, and media documents;
providing a pre-processed analysis of said informational documents;
wherein said pre-processed analysis is an analysis of said informational documents for semantic and conceptual use;
identifying informational documents related to said analyzed content using said pre-processed analysis;
wherein said identifying step identifies related informational documents by finding informational documents that are similar in words, semantically or conceptually, to the analyzed content;
providing a user with a description of each identified informational document;
accepting user input for selecting an identified informational document; and
displaying the selected identified informational document to the user.

15. A process for real time analysis of media content and relating information to the content, comprising the steps of:
extracting metadata from said media content in real time as said content is being viewed by a user;
providing a set of informational documents;
wherein said informational documents comprise any of text, Web, and media documents;
providing a pre-processed analysis of said informational documents;
wherein said pre-processed analysis is an analysis of said informational documents for semantic and conceptual use;
identifying informational documents related to said metadata using said pre-processed analysis;
wherein said identifying step identifies related informational documents by finding informational documents that are similar in words, semantically or conceptually, to said metadata;
providing a user with a description of each identified informational document;
accepting user input for selecting an identified informational document; and
displaying the selected identified informational document to the user.

16. The process of claim 15, wherein a broadcaster provides customized informational documents and specifies their relevance to be used by said identifying step.

17. The process of claim 15, wherein a producer of said media content provides customized informational documents and specifies their relevance to be used by said identifying step.

18. The process of claim 15, wherein said extracting step creates metadata for said media content by analyzing said media content if said media content does not have associated in-band metadata.

19. An apparatus for real time analysis of text and/or media content and relating information to the content, comprising:
a module for analyzing said content in real time;
wherein said analyzing module analyzes said content for semantic and conceptual use;
a set of informational documents;
wherein said informational documents comprise any of text, Web, and media documents;
a pre-processed analysis of said informational documents;
wherein said pre-processed analysis is an analysis of said informational documents for semantic and conceptual use;
a module for identifying informational documents related to said analyzed content using said pre-processed analysis;
a module for providing a user with a description of each identified informational document;
a module for accepting user input for selecting an identified informational document; and
a module for displaying the selected identified informational document to the user.

20. The apparatus of claim 19, wherein said identifying module identifies related informational documents by finding informational documents that are similar in words, semantically or conceptually, to the analyzed content.

21. The apparatus of claim 19, further comprising:
a module for storing descriptors for each informational document.
a module for retrieving descriptions of each identified informational document from said stored descriptors.

22. The apparatus of claim 19, wherein said set of informational documents are stored in a central storage device.

23. The apparatus of claim 19, wherein said pre-processed analysis creates a list of words and calculates the frequency that the words appear in said set of informational documents.

24. The apparatus of claim 23, wherein said pre-processed analysis translates similar words into the same word.

25. The apparatus of claim 19, wherein said pre-processed analysis generates collocations of words that appear together and calculates the frequency of pairs of words and the frequency of the words appearing together in said informational documents.

26. The apparatus of claim 25, wherein said pre-processed analysis finds relations between collocations to learn their meaning/context.

27. The apparatus of claim 19, wherein said pre-processed analysis uses a signature algorithm to calculate signatures for blocks of text, wherein a signature is a vector of words and their weighting within an informational document; wherein the weighting is determined by the importance of a word in the collocations and within the document.

28. The apparatus of claim 27, wherein said pre-processed analysis calculates signatures for Web pages, text tags associated with images, and blocks of text.

29. The apparatus of claim 27, wherein said pre-processed analysis creates an index for each word from a signature vector for an informational document and saves the index, word, text document, and weight of the word into a database that is used to find text documents that have similar signatures.

30. The apparatus of claim 27, wherein said pre-processed analysis uses the signatures and weights of the words to create sets of documents that have similar signatures.

31. The apparatus of claim 19, further comprising:
a module for collecting text documents and multimedia from Web pages across the Internet using a Web crawler and placing them into said set of informational documents.

32. An apparatus for real time analysis of text and/or media content in a workflow application and relating information to the content, comprising:
a module for automatically analyzing said content in real time as said content is being entered or reviewed by a user;
wherein said analyzing module analyzes said content for semantic and conceptual use;
a set of informational documents;
wherein said informational documents comprise any of text, Web, and media documents;
a pre-processed analysis of said informational documents;
wherein said pre-processed analysis is an analysis of said informational documents for semantic and conceptual use;
a module for identifying informational documents related to said analyzed content using said pre-processed analysis;
wherein said identifying module identifies related informational documents by finding informational documents that are similar in words, semantically or conceptually, to the analyzed content;
a module for providing a user with a description of each identified informational document;
a module for accepting user input for selecting an identified informational document; and
a module for displaying the selected identified informational document to the user.

33. An apparatus for real time analysis of media content and relating information to the content, comprising:
a module for extracting metadata from said media content in real time as said content is being viewed by a user;
a set of informational documents;
wherein said informational documents comprise any of text, Web, and media documents;
a pre-processed analysis of said informational documents;
wherein said pre-processed analysis is an analysis of said informational documents for semantic and conceptual use;
a module for identifying informational documents related to said metadata using said pre-processed analysis;
wherein said identifying module identifies related informational documents by finding informational documents that are similar in words, semantically or conceptually, to said metadata;
a module for providing a user with a description of each identified informational document;
a module for accepting user input for selecting an identified informational document; and
a module for displaying the selected identified informational document to the user.

34. The apparatus of claim 33, wherein a broadcaster provides customized informational documents and specifies their relevance to be used by said identifying step.

35. The apparatus of claim 33, wherein a producer of said media content provides customized informational documents and specifies their relevance to be used by said identifying step.

36. The apparatus of claim 33, wherein said extracting step creates metadata for said media content by analyzing said media content if said media content does not have associated in-band metadata.
